(19) United States
(12) Patent Application Publication
(10) Pub. No.: US 2008/0172207 A1
(43) Pub. Date: Jul. 17, 2008

(54) SEMI-AUTOMATED GENERATION OF FRAME STRUCTURES IN CAD MODELS

(76) Inventor: Andrew Philippe Palioca, Happy Valley, OR (US)

Correspondence Address: PATTERSON & SHERIDAN, L.L.P., 3040 POST OAK BOULEVARD, SUITE 1500, HOUSTON, TX, 77056, US

(21) Appl. No.: 11/622,265

(22) Filed: Jan. 11, 2007

(51) Int. Cl. G06F 17/50

(52) U.S. Cl. 703/1

(57) ABSTRACT

Embodiments of the invention include a method for the semi-automated generation of frame structures in a computer-aided design (CAD) model. Advantageously, the disclosed method allows users to create a model of a frame structure directly from the geometry of an existing solid model assembly in a CAD model. For example, endpoints, edges of solid objects, or intersections of surfaces of the solid model assembly may be used as the basis for generating frame members in the CAD model.

### BACKGROUND OF THE INVENTION

1. Field of the Invention

The present invention generally relates to computer software. More specifically, the present invention relates to a method and system for the semi-automated generation of frame structures in CAD models.

2. Description of the Related Art

The term computer-aided design (CAD) generally refers to a broad variety of computer-based tools used by architects, engineers, and other construction and design professionals. In the design work done by a mechanical designer, a frequent task is composing a CAD model to represent a frame structure. CAD model may represent a frame structure using model elements representing structural members, such as steel or aluminum beams connected using some form of end treatment. Frame structures generally fall into one of three general categories: internal, external, and modular.

Internal frames are often the base foundation upon which machines are built. While the majority of these frames are welded together and subsequently machined and painted or otherwise finished, internal frames may also be bolted together using materials left unfinished such as stainless steel or aluminum.

External frames are often required for platforms, access ways and stairwells used for operating and maintaining complex machinery. While in some cases the fabrication of these platforms may be left to the contractors responsible for installing this equipment in factories, in many cases external frames often have an integral relationship with the actual equipment and are therefore designed and built concurrently with the machinery.

Modular framing systems often bolt together using extruded aluminum structural members, standard fasteners and/or engineered specialty corners. They are frequently used to build modular workstations, machinery guards, acoustic baffles and similar structures.

Some CAD applications provide support for generating frame structures in CAD models. However, these systems do not allow a user to create frame members from the solid edges of a part or machine assembly represented in a CAD model. Instead, current applications typically require that a designer compose a wireframe model to serve as the basis for the frame structure in the CAD model. These wireframes are usually created through a series of sketches that copy the geometry of model elements representing a part or component of a machine assembly. Once the wireframe is created, it is then populated with model elements to represent structural frame members. One drawback to this approach is that, in addition to having to create an additional wireframe model just to support the frame model, if the design of the underlying part or machine assembly changes, then the designer must modify the underlying portions of the wire frame affected by the change before updating the actual frame model. This approach has proved to be both tedious and error prone for the users of CAD applications.

As the foregoing illustrates, there is a need in the art for a set of tools that enables mechanical designers to directly generate a frame model for an existing machine assembly or part represented in a CAD model.

### SUMMARY OF THE INVENTION

Embodiments of the invention include a method for the semi-automated generation of frame members in a computer-aided design (CAD) model. The method generally includes receiving a set of desired attributes for a new frame member and a selection of an element of the solid model assembly. For example, the placement of new frame members may be specified by a selection of two or more endpoint locations tangent to the solid model assembly. Alternatively, the placement of new frame members may be specified by a selection of an edge or an intersection of surfaces in the solid model assembly. In a particular embodiment, attributes of the frame member may be based on published standards, such as ones promulgated by the DIN, ANSI, or ISO organizations. The method also includes generating the new frame member having the desired attributes and placing the new frame member in the CAD model. The position of the new frame member in the CAD model is related to the position of the selected element in the CAD model. Additionally, the new frame member may be associated with the element one or more solid modeling assemblies. Subsequent modifications made to the element of the solid model assembly are then used to update any frame members associated with a modified element.

Once frame members are placed in the CAD model, users may select to join a first and second frame member using a variety of possible end treatments. Common end treatments include mitered end treatments, trim-to-frame end treatments, and notched cut treatments.

Still another embodiment of the invention includes computer-readable media storing instructions for performing the previously described method.

Advantageously, the method and system for semi-automated generation of frame structures disclosed by the present invention allows users to create frames directly from the geometry of an existing solid model assemblies in a CAD model, in particular, endpoints, edges of solid objects, or intersections of surfaces of the solid model assembly.

### BRIEF DESCRIPTION OF THE MODELS

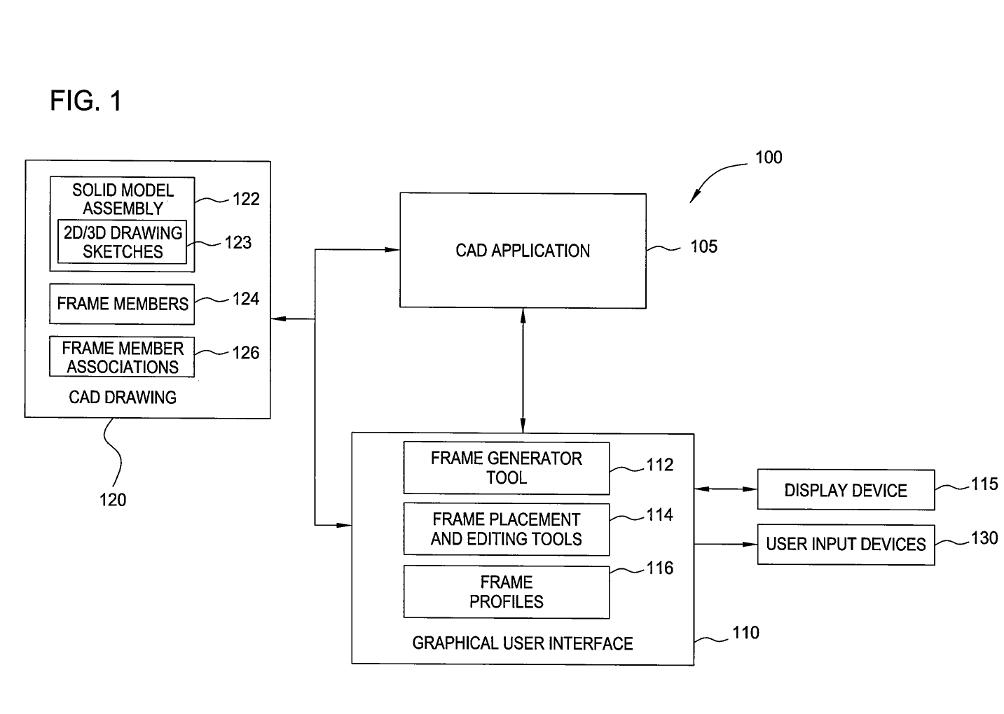

FIG. 1 is a block diagram illustrating components of a CAD application used to generate frame structures for a CAD model, according to one embodiment of the invention.

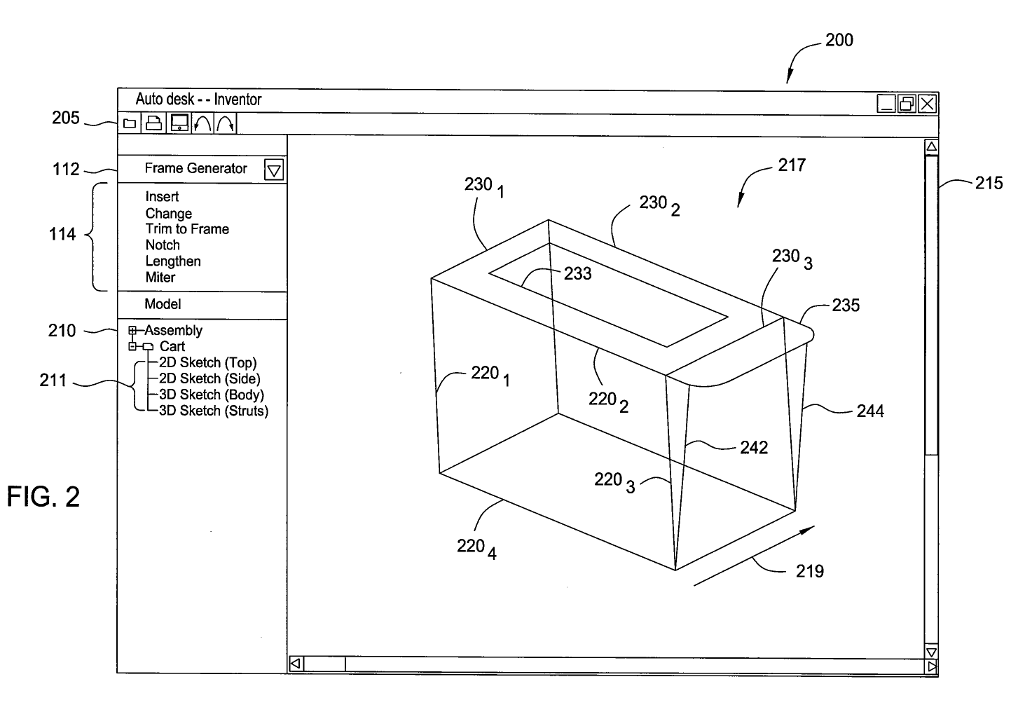

FIG. 2 illustrates a screen display of an exemplary graphical user interface, according to one embodiment of the invention.

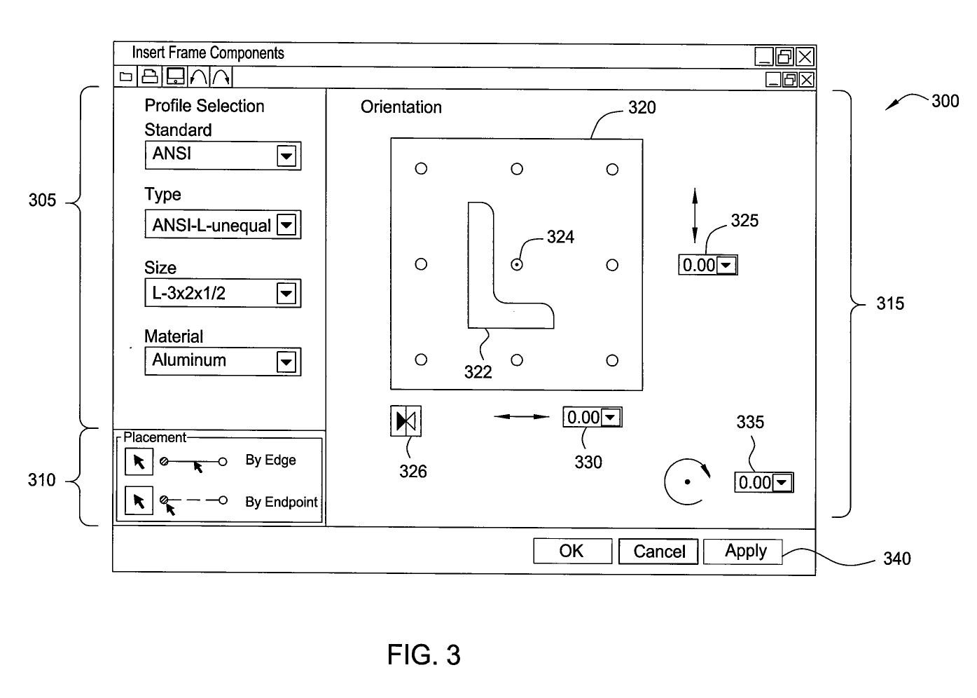

FIG. 3 illustrates an exemplary dialog box used to specify properties of frame members generated for a CAD model, according to one embodiment of the invention.

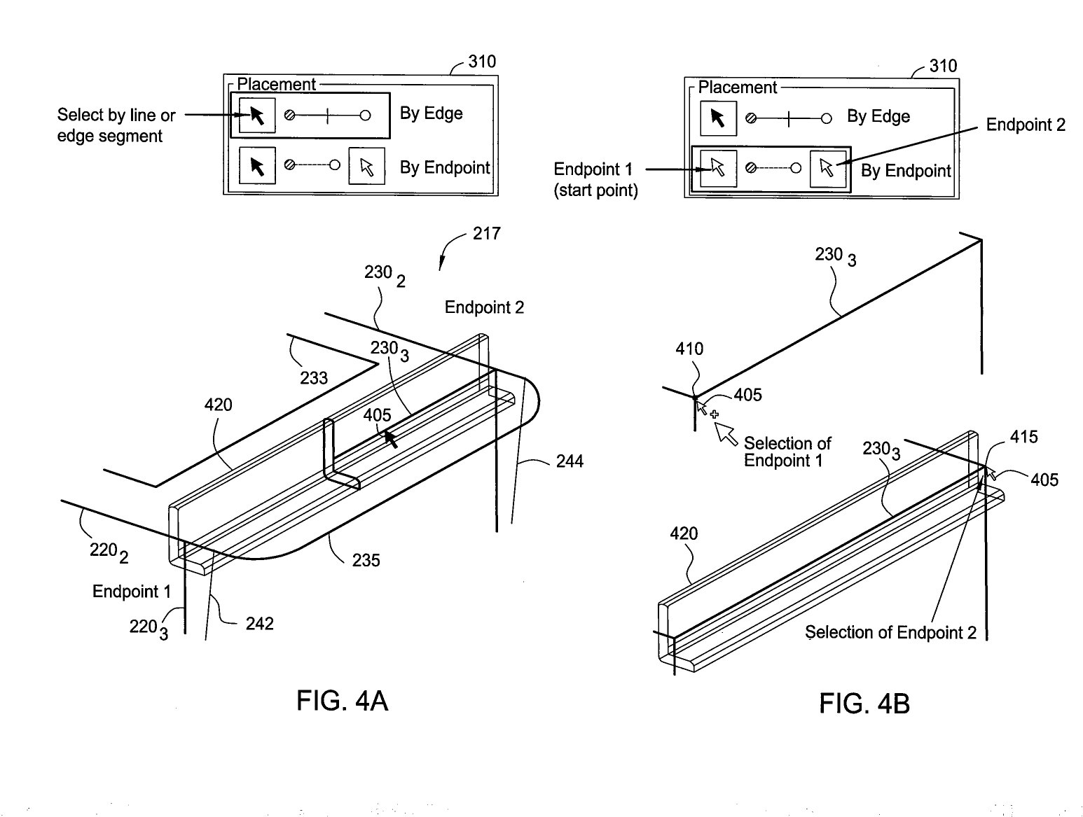

FIGS. 4A-4C are conceptual diagrams illustrating a process for generating frame members for a solid model assembly in a CAD model, according to one embodiment of the invention.

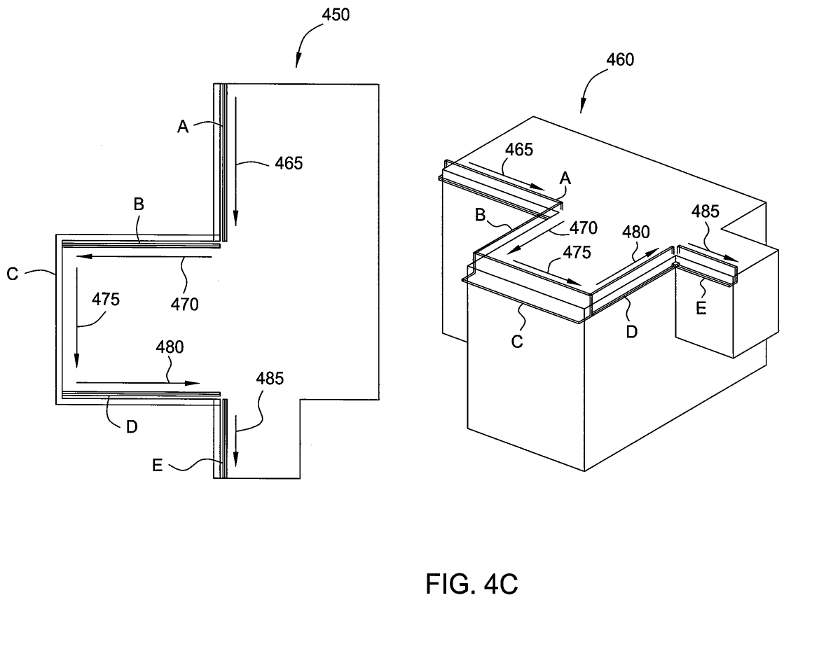

FIG. 5 illustrates a method for the semi-automated generation of frame members in a CAD model, according to one embodiment of the invention.

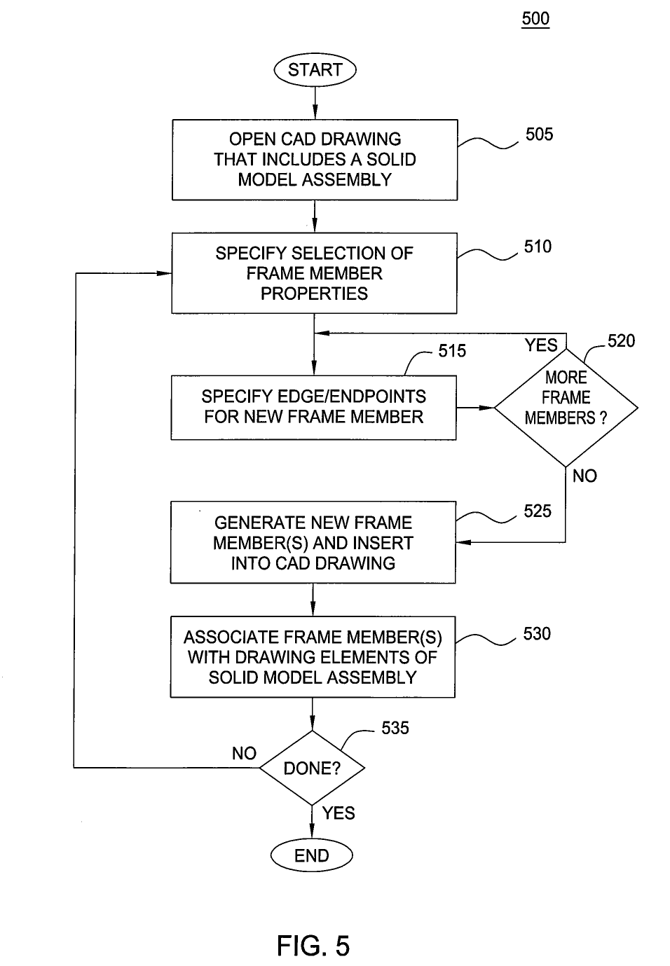

FIG. 6 2 illustrates a screen display of an exemplary graphical user interface showing frame members generated for the solid model assembly first illustrated in FIG. 2, according to one embodiment of the invention.

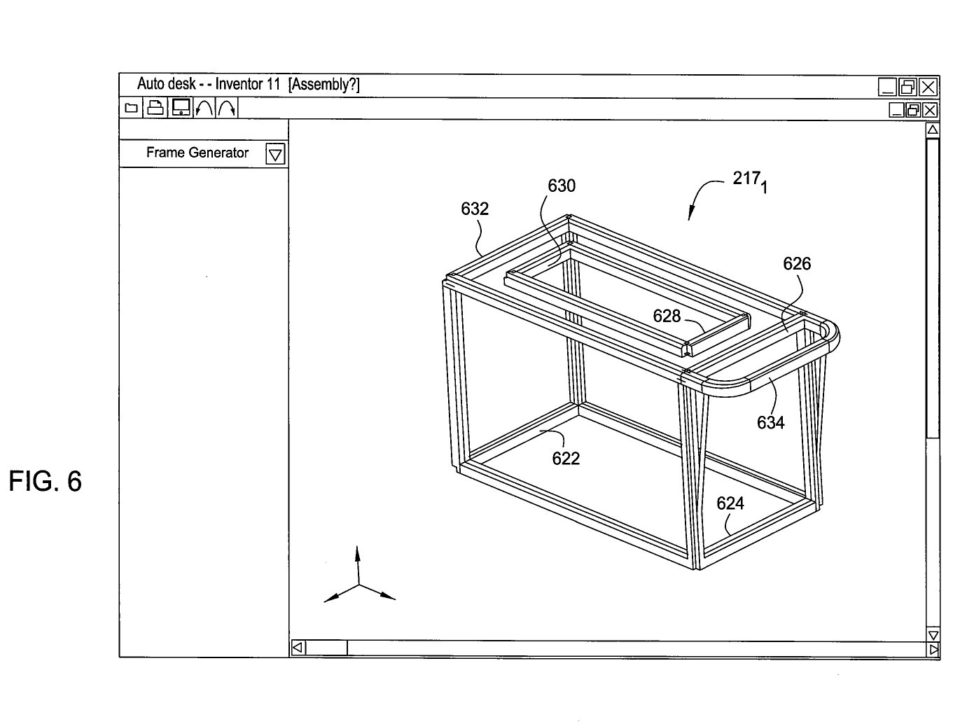

FIG. 7 illustrates a method for applying an end treatment to frame members generated for a solid model assembly, according to one embodiment of the invention.

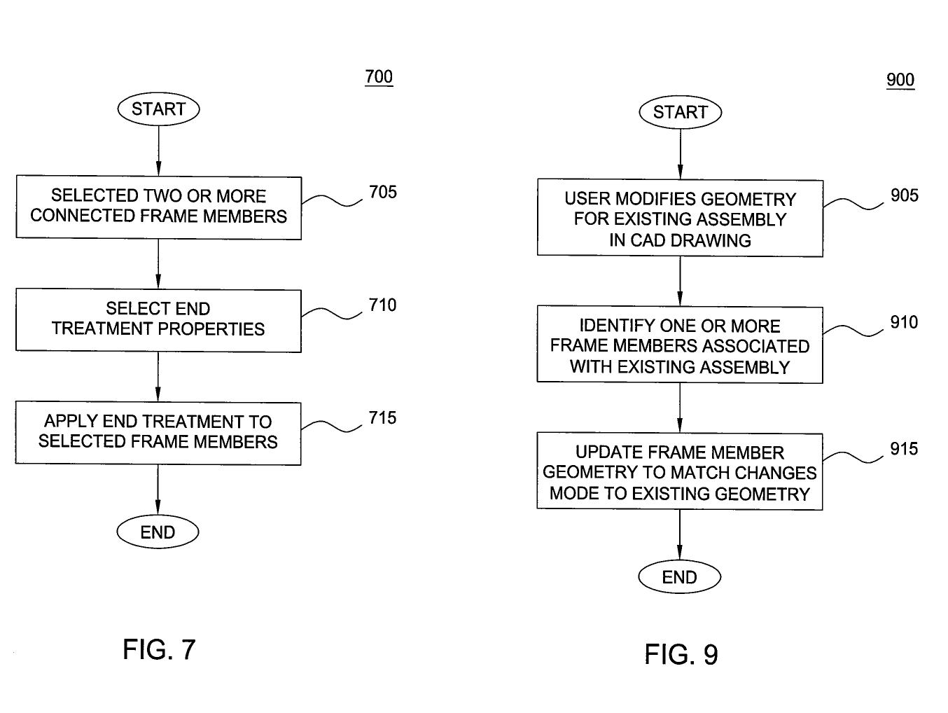

FIG. 8 illustrates three different end treatments that may be applied to two or more connected frame members, according to one embodiment of the invention.

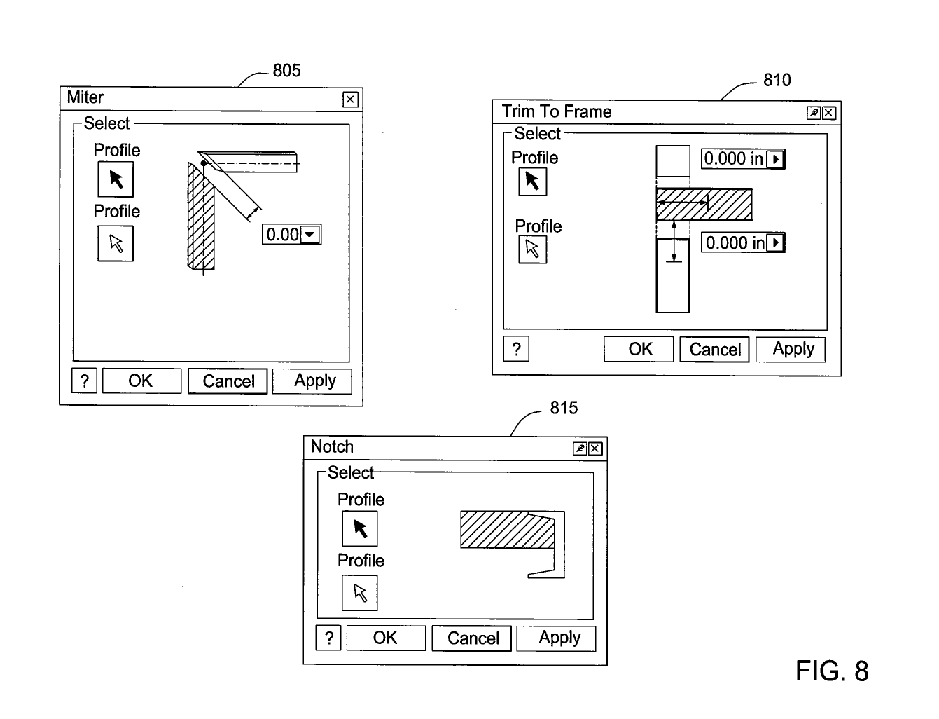

FIG. 9 illustrates a method for updating frame members based on changes to an underlying solid model assembly, according to one embodiment of the invention.

### DETAILED DESCRIPTION OF THE PREFERRED EMBODIMENTS

Embodiments of the invention provide a CAD application configured for the semi-automated generation of frame structures in a CAD model. In one embodiment, a frame generation tool allows the user to specify the profile shape, size, and material to use in generating frame members. Thereafter, the user constructs a frame by selecting elements of an existing solid model assembly in the CAD model. For example, the user may select endpoints, edges, or intersections of surfaces at which to place a desired frame member. Importantly, this allows users to generate frame members directly from the solid model assembly in the CAD model without having to rely on a second wire frame model, or having to manually place frame members in the model. Once the frame member properties and elements of the CAD model are selected, the frame generation tool may be configured to generate and insert model elements representing the frame members into the CAD model.

Additionally, the CAD application may be configured to provide information such as a bill of materials or a cut list to use in constructing the actual frame represented in the CAD model. Further, if the solid model assembly in a CAD model is modified, the CAD application may be configured to update the frame members within the CAD model.

FIG. 1 is a block diagram illustrating components of a system 100 used to generate frame structures for a solid model assembly in a CAD model, according to one embodiment of the invention. The components illustrated in system 100 may include computer software applications executing on existing computer systems, e.g., desktop computers, server computers, laptop computers, tablet computers, and the like. The software applications described herein, however, are not limited to any particular computing system and may be adapted to take advantage of new computing systems as they become available.

Additionally, the components illustrated in system 100 may be implemented as software applications that execute on a single computer system or on distributed systems communicating over computer networks such as local area networks or large, wide area networks, such as the Internet. For example, a graphical user interface 110 may include a software program executing on a client computer system at one physical location communicating with CAD application 105 at another physical location. Also, in one embodiment, CAD application 105 and graphical user interface 110 may be provided as an application program (or programs) stored on computer readable media such as a CD-ROM, DVD-ROM, flash memory module, or other tangible storage media.

As shown, the system 100 includes, without limitation, CAD application 105, graphical user interface 110, a CAD model 120, user input devices 130, and a display device 115. CAD application 105 may be configured to allow users interacting with GUI interface 110 to compose a CAD model 120. Accordingly, CAD application 105 and GUI interface 110 may include programmed routines or instructions allowing users to create, edit, load, and save CAD model 120. In one embodiment, the Autodesk® Inventor™ application program (and associated utilities) may be used. Those skilled in the art will recognize, however, that the components shown in FIG. 1 are simplified to highlight aspects of the present invention and that a typical CAD application 105 and GUI interface 110 may include a broad variety of additional tools and features used to compose and manage CAD model 120.

Illustratively, CAD model 120 includes a solid model assembly 122, frame members 124, and frame member associations 126. Solid model assembly 122 provides a virtual three-dimensional (3D) representation of a real-world object. Frame members 124 represent components used in the construction of a frame. For example, common frame members may represent real-world components such as steel, “angle iron,” round, square, and rectangular, tubing, “C” channels, “I” beams, etc. Frame member associations 126 specify which elements of solid model assembly 122 are related to a given frame member 124.

In one embodiment, GUI 110 allows users to compose and edit solid model assembly 122. For example, the Inventor™ application provides a parametric modeling tool used by designers and engineers to produce and perfect new products. Whereas non-parametric CAD programs the dimensions are geometry-driven, a parametric modeling application allows the geometry of solid model assembly 122 to be dimension-driven. That is, if the dimensions are altered, the geometry automatically updates based on the new dimension. Using the Inventor™ application, users compose solid model assembly 122 by first designing certain parts, and the parts may then be combined to form solid model assembly 122. Parts are composed from one or more sketches 123. For example, in order to compose a solid model assembly of a simple cube, a user would first create a sketch having a square within a two-dimensional (2D) plane, and then use an extrude tool to create the three dimensional cube. The user could then add a shaft extending from cube by adding a sketch to the desired face of the cube, sketch a circle, and then extruding that circle to create a shaft. The cube and shaft may then be connected to other parts to form solid model assembly 122.

New assemblies can consist of both parts and other assemblies. The parametric modeling approach used by the Inventor™ application allows users to create three-dimensional models having virtually any desired level of detail. However, embodiments of the invention may be adapted for use with non-parametric modeling applications. As described in greater detail herein, once a solid model assembly 122 is available, the user may generate frame members 124 directly from endpoints, edges, or intersections of surfaces present in solid model assembly 122.

Also as shown, GUI 110 includes a frame generator tool 112, frame placement and editing tools 114 and frame profiles 116. Frame generator tool 112 allows a user to specify the profile shape, size, and material to use when generating frame members 124. And frame placement and editing tools 114 allow a user to specify which elements of solid model assembly 122 should be used to generate frame members 124. Frame profiles 116 may provide a selection of frame types. For example, frame profiles 116 may include frame member profiles conforming to various standards such as the ANSI, ISO, DIN, standards, to name but a few. However, no particular standard is required, and frame profiles 116 may include both standardized and custom profiles to use in generating frame members 124.

FIG. 2 illustrates a screen display 200 of an exemplary GUI 110, according to one embodiment of the invention. As shown, screen display 200 includes a toolbar 205, frame generator tool 112, a model component panel 210, and a display panel 215. Toolbar 205 includes buttons used to create, edit, save, undo and redo edits made to a CAD model 120 displayed in display panel 215.

Illustratively, display panel 215 shows a rendering of a solid model assembly, in this case, a rectangular cart 217. Cart 217 is composed from a 3D solid model with attached 2D and 3D sketches 211 listed in model component panel 210. Specifically, cart 217 includes a 3D model for the body of the cart which has been generated by extruding the 2D sketch of the side of the cart that includes edges 2201, 2202, 2203, and 2204 to form the solid geometry of the cart (as indicated by an arrow 219). A 2D sketch for the top of the cart is created from the top of the solid body and includes outer edges 230₁, 230₂, 230₃, 220₂, inner edges 233, a handle 235. Additionally, the cart includes a 3D sketch for struts 242 and 244 that support handle 235.

In one embodiment, frame generator tool 112 includes commands 114 used to create frame members for a solid model assembly. As shown, commands 114 include commands to insert new frame members, change the properties of existing frame members, along with commands used to specify an end treatment to apply to two or more frame members.

FIG. 3 illustrates an exemplary dialog 300 box corresponding to an “insert” command included in commands 114, according to one embodiment of the invention. As shown, dialog box 300 includes a selection panel 305, a placement panel 310, and a profile orientation panel 315. Selection panel 305 allows the user to specify the desired characteristics to use in generating frame members 124. Illustratively, profile selection panel 305 shows settings for an ANSI standard “L” shaped frame member with dimensions of 3″×2″×½″ made from aluminum.

Placement panel 310 specifies whether frame generation tool 112 should create frame members based on a user selecting edges from a solid model assembly or by specifying desired endpoints for a frame member. Profile orientation panel 315 allows the user to control the orientation of frame members 124 inserted into CAD model 120. As shown, profile orientation panel 315 includes an orientation view 320, a frame member profile 322, placement radio buttons 324, a vertical offset tool 325, a horizontal offset tool 330, a rotation offset tool 335, and a profile mirroring tool 326. Frame profile 322 displays a cross section of the frame member specified in selection panel 305. How frame members are oriented, relative to a given solid model assembly may be adjusted using the user interface tools shown in orientation panel 315.

Illustratively, the positioning of a frame member may be specified by selecting one of radio buttons 324. The base position may be offset in a horizontal direction using horizontal offset 330, in a vertical direction using vertical offset 325, rotated using rotation tool 336, or flipped using a mirror image button 326. Once a user has specified the desired properties and orientation for frame members 124, the user may confirm their selection using apply button 340. Thereafter, the user may place frame members in a CAD model using the selected placement method displayed in placement panel 310.

FIGS. 4A-4C are conceptual diagrams illustrating different placement methods for generating frame members for a solid model assembly. FIG. 4A illustrates an edge-based placement method, according to one embodiment of the invention. The placement panel 310 of FIG. 3 is shown set to “by edge” and a frame member preview 425 is shown for edge 230₃ of cart 217. Using edge-based placement, users place frame members by selecting individual lines, edges, or intersections of solid surfaces in solid model assembly 122. Frame member preview 425 is generated according to the profile and orientation data specified in selection panel 305 and profile orientation panel 315. To place a frame member using the edge-based placement method, a user positions mouse cursor 405 over an edge of a solid model assembly. In one embodiment, individual lines, edges, or intersections of solid surfaces may be highlighted as a mouse cursor 405 passes over them.

FIG. 4B illustrates an endpoint-based placement method, according to one embodiment of the invention. The placement panel 310 of FIG. 3 is shown set to “by endpoint” and a frame member preview 420 is shown for edge 2₃ of cart 217. Using endpoint-based placement, frame members may be created one at a time between selected endpoints. Illustratively, mouse cursor 405 is shown selecting a first endpoint 410 and then a second endpoint 415. In one embodiment, as mouse cursor 405 passes over an endpoint for the model elements of solid model assembly, that endpoint is highlighted to indicate that it may be used as the beginning (or ending) endpoint for frame member placement. As shown in FIG. 4B, the user has selected endpoints 410 and 415 that represent adjacent corners of a solid model assembly.

In one embodiment, when using an edge-based placement or an endpoint-based placement method, the user may select multiple edges or endpoints. FIG. 4C illustrates a process for multi-select frame member placement, according to one embodiment of the invention. As shown, FIG. 4C includes a top view 450 of a 3D solid model, and a 3D perspective view 460 of the 3D solid model. Frame members A, B, C, D, and E have been added by sequentially selecting edges 465, 470, 475, 480, and 485, as shown by the direction of the arrows running parallel to each edge in top view 450 and perspective view 460. In one embodiment, the orientation for the first frame member added to a solid model assembly is propagated to each sequential edge/endpoint selected by the user.

FIG. 5 illustrates a method 500 for the semi-automated generation of frame members in a CAD model, according to one embodiment of the invention. Persons skilled in the art will understand that any system configured to perform the steps of method 500, in any order, is within the scope of the present invention.

As shown, the method 500 begins at step 505, where a user opens an existing CAD model that includes a solid model assembly. Alternatively, the user may create a new solid model assembly by interacting with GUI 110. At step 510, the user may specify a selection of frame member properties. For example, GUI 110 may provide a frame generator tool 112 like the one illustrated in FIGS. 2 and 3. Once the user specifies the desired frame member characteristics, at step 515, the user may pick edges/endpoints on the solid model assembly at which to place a frame member. At step 520, the selection process may continue, allowing the user to select multiple edges/endpoints. After all the desired edges/endpoints for which frame members should be generated have been specified, at step 525, new frame members are generated and inserted into CAD model. At step 530, the new frame members may be associated with their corresponding edges/endpoints. At step 535, the user may select to modify the frame member properties and/or create new frame members for additional edges/endpoints of the solid model assembly. After all the desired frame members have been created, the method 500 terminates.

FIG. 6 illustrates a screenshot of a graphical user interface of a CAD application showing an example of frame members generated for the solid model assembly of FIG. 2, according to one embodiment of the invention. As shown, each edge of cart 217 now includes a frame member. The location and position of the fame members correspond to the 2D and 3D sketches 211 defining cart 217, as described in FIG. 2. Additionally, each frame member is specifically associated with elements of the solid model assembly so that, if the user modifies one of these sketches of solids, then the frame members may be automatically updated accordingly. For example, if the size of the extrusion forming the body of cart 217 were enlarged, then the lengths of frame members 622, 624, 626, 628, 630, 632 and 634 would be updated without the need for the user to redesign any of these frame members.

Embodiments of the invention may also allow users to specify end treatments to apply to frame members generated according to the techniques described herein. Generally, an end treatment is used to specify the particular geometry of a first frame member where it joins a second frame member. Commonly used end treatments include, without limitation, mitered, notched, trimmed, butted, etc.

FIG. 7 illustrates a method 700 for applying an end treatment to frame members generated from a solid model assembly, according to one embodiment of the invention. Persons skilled in the art will understand that any system configured to perform the steps of method 700, in any order, is within the scope of the present invention.

As shown the method 700 begins at step 705, where a user selects two or more connected frame members. At step 710, the user may specify the desired end treatment to apply to the frame members selected at step 705. At step 715, the end treatment is applied to the frame members, modifying the geometry as specified by the end treatment type.

FIG. 8 illustrates three different end treatments that may be applied to two or more connected frame members, according to one embodiment of the invention. More specifically, a dialog box 805 illustrates a mitered end treatment, a dialog box 810 illustrates a trim-to-frame end treatment, and a dialog box 815 illustrates a notched end treatment. Of course, other end treatments may be made available in different cases. In one embodiment, the user may access different end treatments using the frame placement and editing tools 114 shown in FIGS. 1 and 2. A mitered end treatment is formed by beveling the edges or ends of two selected frame member pieces. A common miter involves beveling both frame members at 45-degree angles and then joining them together to form a 90-degree angle. A trim-to frame end treatment reduces the length of a first frame member to be tangent to a second frame member. The resulting frame members may then be welded together to form a single functional unit. A notched frame end treatment removes a portion of a first frame member in a manner that allows a second frame member to fit within the notch, forming a natural joint between the two frame members.

Once a set of frame members are created and inserted into CAD model 120, they may be updated automatically as the solid model assembly is changed. FIG. 9 illustrates a method 900 for updating frame members based on changes to an underlying solid model assembly, according to one embodiment of the invention. Persons skilled in the art will understand that any system configured to perform the steps of method 900, in any order, is within the scope of the present invention.

The method 900 begins at step 905, where an element of the solid model assembly is modified. In response, at step 910, CAD application 105 may be configured to identify one or more frame members associated with the modified elements of the solid model assembly. For example, frame member associations 126 of FIG. 1 specify which elements of solid model assembly 122 are related to a given frame member 124 within CAD model 120. At step 915, CAD application 105 may update the geometry for the frame members 124 identified at step 910.

Advantageously, the methods described herein for generating frame structures allow users to create frames from the model elements of an existing solid model assembly—in particular, from the endpoints, edges of solid objects, or intersections of surfaces in a CAD model. Designers often compose a CAD model of a frame structure based on the particular kind of equipment the actual frame is intended to support, and the frame structure is highly dependent upon the geometry of the equipment. Thus, designing frame structures directly from model elements representing the size, shape, and position of such equipment provides a clear advantage to current techniques. Further, as the design of the equipment may change, linking the frame structures to the actual model elements allows the frame to be easily updated based on changes made to the geometry of the underlying equipment.

While the foregoing is directed to embodiments of the present invention, other and further embodiments of the invention may be devised without departing from the basic scope thereof, and the scope thereof is determined by the claims that follow.

What is claimed is:

1. A method for generating frame members for a solid model assembly in a computer-aided design (CAD) model, comprising:
receiving a set of desired attributes for a new frame member;
receiving a selection of an element of the solid model assembly;
generating the new frame member having the desired attributes;
placing the new frame member into the CAD model, wherein the position of the new frame member in the CAD model is related to the position of the selected element in the CAD model; and
associating the new frame member with the element of the solid model assembly.

2. The method of claim 1, wherein the placement of the new frame member in the CAD model is specified by a selection of two or more endpoint locations tangent to the solid model assembly.

3. The method of claim 1, wherein the placement of the new frame member in the CAD model is specified by a selection of an edge or an intersection of surfaces in the solid model assembly.

4. The method of claim 1 further comprising:
modifying the element of the solid model assembly; and
updating the new frame member to reflect the modification of the element.

5. The method of claim 1, wherein the set of desired attributes specify a cross-sectional profile, size, and orientation for the new frame member to be generated.

6. The method of claim 1, wherein the set of desired attributes is based on a formal standard specifying frame member properties.

7. The method of claim 1, further comprising,
receiving a selection of a first frame member and a second frame members in the CAD model;
receiving a selection of an end treatment used to join the first and second frame members; and
modifying the first and second frame members in the CAD model to be joined according to the selected end treatment.

8. The method of claim 7, wherein the end treatment is a mitered end treatment, a trim-to-frame end treatment, or a notched end treatment.

9. A computer-readable medium storing instructions for generating frame members for a solid model assembly in a computer-aided design (CAD) model, including instructions for performing the steps of:
receiving a set of desired attributes for a new frame member;
receiving a selection of an element of the solid model assembly;
generating the new frame member having the desired attributes;
placing the new frame member into the CAD model, wherein the position of the new frame member in the CAD model is related to the position of the selected element in the CAD model; and
associating the new frame member with the element of the solid model assembly.

10. The computer-readable medium of claim 9, wherein the placement of the new frame member in the CAD model is specified by a selection of two or more endpoint locations tangent to the solid model assembly.

11. The computer-readable medium of claim 9, wherein the placement of the new frame member in the CAD model is specified by a selection of an edge or an intersection of surfaces in the solid model assembly.

12. The computer-readable medium of claim 9, wherein the operations further comprise:
modifying the element of the solid model assembly; and
updating the new frame member to reflect the modification of the element.

13. The computer-readable medium of claim 9, wherein the set of desired attributes specify a cross-sectional profile, size, and orientation for the new frame member to be generated.

14. The computer-readable medium of claim 9, wherein the set of desired attributes is based on a formal standard specifying frame member properties.

15. The computer-readable medium of claim 9, further comprising,
receiving a selection of a first frame member and a second frame members in the CAD model;
receiving a selection of an end treatment used to join the first and second frame members; and
modifying the first and second frame members in the CAD model to be joined according to the selected end treatment.

16. The computer-readable medium of claim 15, wherein the end treatment is a mitered end treatment, a trim-to-frame end treatment, or a notched end treatment.

17. A method for generating frame members for a solid model assembly in a computer-aided design (CAD) model, comprising:
selecting a set of attributes for a new frame member;
selecting an element of the solid model assembly; and
invoking a frame generation tool configured to:
generate the new frame member having the desired attributes;
place the new frame member into the CAD model, wherein the position of the new frame member in the CAD model is related to the position of the selected element in the CAD model; and
associate the new frame member with the selected element of the solid model assembly.

18. The method of claim 17, wherein selecting an element of the solid model assembly comprises specifying a selection of two or more endpoint locations tangent to the solid model assembly.

19. The method of claim 17, wherein selecting an element of the solid model assembly comprises specifying a selection of an edge or an intersection of surfaces in the solid model assembly.

20. The method of claim 17, further comprising the steps of,
selecting a first frame member and a second frame member in the CAD model;
selecting an end treatment to join the first and second frame members; and
invoking an end-treatment tool configured to modify the representation of the first and second frame members in the CAD model to be joined according to the selected end treatment.
